(19) United States
(12) Patent Application Publication
(10) Pub. No.: US 2026/0078059 A1
(43) Pub. Date: Mar. 19, 2026

(54) SOLID ALKALI-ACTIVATED BINDER FORMULATIONS

(71) Applicant: Louisiana Tech Research Corporation; of Louisiana Tech University Foundation, Inc., Ruston, LA (US)

(72) Inventors: John Matthews, Choudrant, LA (US); Hussain Shaik, Ruston, LA (US); Niloy Paul, Ruston, LA (US); Richard Edwards, St. Francisville, LA (US)

(21) Appl. No.: 19/333,648

(22) Filed: Sep. 19, 2025

Related U.S. Application Data
(60) Provisional application No. 63/696,510, filed on Sep. 19, 2024.

(51) Int. Cl. C04B 28/26; C04B 18/10; C04B 22/10; C04B 103/10

(52) U.S. Cl. CPC C04B 28/26; C04B 18/101; C04B 22/10; C04B 2103/10

(57) ABSTRACT

A one-part, cement-free, ready-to-use, powdered, solid alkali-activated binder formulation for making a high strength and early setting material when combined with an aggregate and water. The solid alkali-activated binder includes slag and a solid metal carbonate-based alkali activator.

### CROSS-REFERENCE TO RELATED APPLICATIONS

This application claims the benefit of and priority to U.S. Provisional Patent Application No. 63/696,510, filed on Sep. 19, 2024, the entire contents of which are incorporated herein by reference.

### TECHNICAL FIELD

The present disclosure generally relates to one-part cement-free ready-to-use solid alkali-activated binder formulations and methods for making them. The solid alkali-activated binder formulations may be produced from a single precursor and single activator. The solid alkali-activated binder formulations may be for civil engineering applications and processes thereof.

### BACKGROUND

Unless otherwise indicated herein, the materials described in this section are not prior art to the claims herein and are not admitted as being prior art by inclusion in this section.

Portland cement has been used as a primary binding material for civil engineering concrete construction applications. The cement industry is a significant user of energy and natural resources and ranks among the leading producers and emitters of carbon dioxide (CO2). The process of burning fuel and decarbonizing limestone produces between 0.66 to 0.85 tons of CO2 for every ton of cement produced, accounts for 8-10% of all CO2 emissions, and uses more than 2.5 tons of natural fuels and raw materials.

Geopolymers have been explored as a potential binding material in concrete. However, the use of corrosive and hazardous alkaline activators and high temperature curing complicate the safe use of the technology and implementation of it in the field. Typical activators used in geopolymers include sodium silicate solution and sodium hydroxide solution, individually or together, which have high hygroscopicity and low solubility, respectively. A 50% sodium hydroxide solution has a pH value of 14 and hence is classified as corrosive and hazardous to handle as per Occupational Safety and Health Act (OSHA). Sodium silicate solution as an activator results in high shrinkage of a specimen and may be difficult to use due to poor workability. High amounts of heat produced by an exothermic reaction make sodium silicate solution difficult to handle in large scale construction projects.

Potassium-based activation of materials using potassium hydroxide and potassium silicate solutions have similar drawbacks and are expensive. Calcium hydroxide as an activator has low solubility issues. Acid-based activation involves the use of acidic solutions such as phosphoric acid to initiate the activation process and the drawbacks of this activation outweigh any advantages as they involve safety issues, equipment degradation, material incompatibility, and neutralization costs.

### SUMMARY

Existing challenges associated with the foregoing, as well as other challenges, are overcome by the presently disclosed powdered binder formulation. One embodiment of the present disclosure is a one-part, cement-free, ready-to-use, powdered, solid alkali-activated binder formulation for making a high strength and early setting material when combined with an aggregate and water. The solid alkali-activated binder formulation includes slag and a solid metal carbonate-based alkali activator.

In aspects, the slag is blast furnace slag, steel slag, electric furnace slag, ladle slag, nonferrous slag, and/or combinations thereof.

In aspects, the slag is blast furnace slag and has a comprehensive basicity of about 0.85 to about 4.0.

In aspects, the slag is blast furnace slag and has a comprehensive basicity of about 0.85 to about 1.20.

In aspects, slag has an amount of CaO of about 10% to about 60% by weight of the slag.

In aspects, a ratio of alumina to silica of the slag is about 0.05:6.0.

In aspects, the activator includes at least one of sodium carbonate, potassium carbonate, magnesium carbonate, or mixtures thereof.

In aspects, the activator is sodium carbonate which is 99% pure with a metal oxide equivalent ranging from about 1.0 to about 3.0.

In aspects, the solid alkali-activated binder formulation includes about 80% to about 98% by weight range of the slag and about 2% to about 20% by weight of the metal carbonate-based alkali activator.

In aspects, the solid alkali-activated binder formulation further includes a solid alkaline silicate activator.

In aspects, the alkaline silicate activator includes at least one of sodium silicate, potassium silicate, or combinations thereof.

In aspects, the alkaline silicate activator includes 99% pure sodium silicate anhydrous or pentahydrate.

In aspects, the alkali-activated binder includes about 80% to about 96% by weight range of the slag, about 2% to about 10% by weight of the metal carbonate-based alkali activator, and about 2% to about 10% by weight of the alkaline silicate activator.

In aspects, the solid alkali-activated binder formulation further includes biochar.

In aspects, the biochar includes rice husk, sawdust, bamboo waste, dry grass, sugar cane, sludge, corn cob, or mixtures thereof.

In aspects, the biochar includes granular, angular, elongated or fine powdered biochar derived from rice husk.

In aspects, the biochar has a specific gravity in the range of about 0.40 to about 0.80.

Another embodiment of the present disclosure includes a method of making a solid alkali-activated binder formulation. The method includes placing slag into a chamber of milling equipment. A solid metal carbonate-based alkali activator is placed into the chamber of the milling equipment. The method includes grinding the slag and the metal carbonate-based alkali activator to produce a dry solid powder solid alkali-activated binder formulation for making a high strength and early setting material when combined with aggregate and water.

In aspects, the method further includes mixing aggregate and water with the dry solid powder to produce a mortar and casting the mortar into a mold.

Another embodiment of the present disclosure is a one-part, cement-free, ready-to-use, powdered, solid alkali-activated binder formulation for making a high strength and early setting material when combined with aggregate and water. The solid alkali-activated binder includes blast furnace slag with a comprehensive basicity in a range of about 0.85 to about 1.20 and an amount of CaO in a range of about 10% to about 60% by weight of the slag. The solid alkali-activated binder includes solid sodium carbonate as a metal carbonate-based alkali activator. The solid alkali-activated binder includes about 80% to about 98% by weight of the blast furnace slag and about 2% to about 20% by weight of the metal carbonate-based alkali activator.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 illustrates an exemplary system that can be utilized to produce a solid alkali-activated binder in accordance with the present disclosure;

FIG. 2 illustrates another exemplary system that can be utilized to produce a solid alkali-activated binder in accordance with the present disclosure; and

FIG. 3 illustrates yet another exemplary system that can be utilized to produce a solid alkali-activated binder with the present disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

Compositions may be a one-part cement-free alkali-activated ready-to-use powdered solid alkali-activated binder as a complete or partial replacement of cement to achieve superior mechanical and durability properties when used in mortar or concrete in field applications. Such solid alkali-activated binder may be an economical, environmentally friendly, and sustainable alternative to cement which is known for its adverse effects on the environment and global warming.

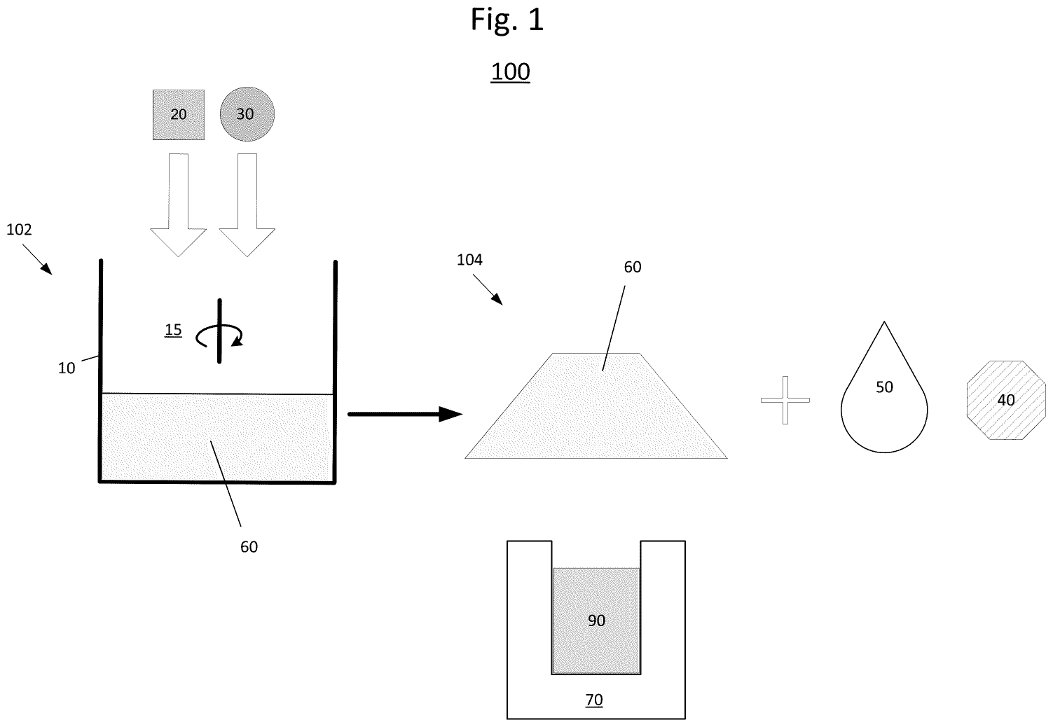

FIG. 1 illustrates an exemplary system that can be utilized to produce a solid alkali-activated binder arranged in accordance with at least some embodiments described herein. As discussed in more detail below, the solid alkali-activated binder produced using system 100 may be a one-part cement-free alkali-activated ready-to-use powdered binder and an effective building material for general construction.

System 100 may include milling equipment 10 with a chamber 15, slag 20, an activator 30, aggregate 40, water 50, and a mold 70. Milling equipment 10 may dry grind material placed within chamber 15. Milling equipment 10 may be a horizontal or vertical milling machine, a jar mill, a ball mill, or a household mixer. Milling equipment 10 may be advanced types of machinery such as a planetary mill, an industrial vertical roller mill, or any other milling device.

Slag 20 may be blast furnace slag, steel slag, electric furnace slag, ladle slag, nonferrous slag, and/or combinations thereof. In aspects, slag 20 may be blast furnace slag. Slag 20 may be a single precursor and may be a by-product of smelting ores and metals. Slag 20 may have a comprehensive basicity (ratio of basic oxides to acidic oxides, (CaO+MgO+FeO)/(SiO₂+Al₂O₃)) in a range of about 0.85 to about 4.0. Slag 20 may have a comprehensive basicity between 0.85 to 1.20. An amount of CaO in slag 20 may be in a range of about 10% to about 60% by weight of slag 20, in aspects around about 30% to about 50%. A ratio of alumina to silica of slag 20 may be about 0.05:6.0, in aspects about 0.20:0.85. A specific gravity of blast furnace slag 20 may be about 2.50.

Activator 30 may be a solid metal carbonate-based alkali activator. Activator 30 may include metal carbonate in the form of powder, flakes, beads or granules. Activator 30 may be at least one of sodium carbonate, potassium carbonate, magnesium carbonate, or mixtures thereof. Activator 30 may be sodium carbonate which may be 99% pure with a metal oxide equivalent ranging from about 1.0 to about 3.0.

At 102, slag 20 and activator 30 may be placed separately, or in any combination, into chamber 15 of milling equipment 10. Milling equipment 10 may dry grind slag 20 and activator 30 into a dry powder 60. For the purpose of the present disclosure, the term grinding represents milling, pulverizing or mixing of components. Milling equipment 10 may dry grind dry slag 20 and activator 30 in solid form at an rpm ranging from 30 to 20,000. Milling equipment 10 may dry grind slag 20 and activator 30 for a duration ranging from about 5 minutes to about 540 minutes. In aspects milling equipment 10 may dry grind dry slag 20 and activator 30 in solid form at an rpm ranging from 30-90 for a duration of about 60 minutes to about 240 minutes. In other aspects, milling equipment 10 may dry grind dry slag 20 and activator 30 in solid form at an rpm ranging from 30-90 for a duration of about 60 minutes to about 240 minutes Milling may be performed to obtain simultaneous and synergistic chemical reactions among slag 20 and activator 30 so as to convert the material from unreactive to reactive and produce a powder capable of instant activation when in contact with water. Milling may be performed on slag 20 and activator 30 to obtain enhanced functionality for achieving bonding of the constituents within the binder concrete system to obtain desired functionality for a targeted application. Dry powder 60 may be a ‘ready-to-use powdered binder’ and may be a dry fine powder which may only require the addition of water to harden and form a cement-like material.

At 104, dry powder 60 may be removed from milling equipment 10, dry powder 60 may include milled slag 20 and milled activator 30 and may have particles of a uniform size ranging from between submicron to nano. Dry powder 60 may have particles from about 20 microns to about 150 microns. Dry powder 60 may be a one-part cement-free alkali-activated ready-to-use powdered binder from a single slag precursor and a single activator. One-part cement-free alkali-activated ready-to-use powdered binder of dry powder 60 may include about 80% to about 98% by weight of slag 20 and about 2% to about 20% by weight of metal carbonate-based alkali activator 30.

Water 50 and optional aggregate 40 may be added to solid alkali-activated binder dry powder 60 to form a mortar for casting the materials in a mold 70 of desired dimensions. Aggregates 40 may be both fine (<4.75 mm sand) and coarse (4.75-20 mm river rock, crushed rocks or ballast stones) and when mixed with solid alkali-activated binder dry powder 60 and water 50 may result in a manufacture mortar or concrete. Solid alkali-activated binder dry powder 60 may not require the addition of a hazardous alkaline activator solution to make cementitious materials. Solid alkali-activated binder dry powder 60 mixed with water 50 may harden/set at temperatures of 65° F. to 90° F. resulting in mortar 90.

Table 1 includes examples of mortar formulations for solid alkali-activated binder powder 60 made from slag 20 and a single activator 30. Table 1 includes compressive strength values of 7-day and 28-day ambient cured mortar made from solid alkali-activated binder powder 60.

TABLE 1

| | | | | | Compressive | | |
|---|---|---|---|---|---|---|---|
| | Binder (g) | | | | strength (psi) | | |
| | | Solid Sodium | Fine | | 7-day | 28-day | |
| Example | Slag | carbonate | aggregate | Water | ambient | ambient | |
| Number | (Precursor) | (Activator) | (g) | (g) | cured | cured | |
| 1 | 337.32 | 16.87 | 531.56 | 114.25 | 5123 psi | 7578 | psi |
| | | | | | 5516 psi | 7123 | psi |
| | | | | | 5342 psi | 7980 | psi |
| 2 | 325.35 | 32.53 | 537.12 | 105.00 | 5618 psi | 8931 | psi |
| | | | | | 5230 psi | 8898 | psi |
| | | | | | 5771 psi | 9235 | psi |
| 3 | 313.32 | 47.00 | 540.47 | 99.22 | 8821 psi | 11352 | psi |
| | | | | | 8343 psi | 10502 | psi |
| | | | | | 7051 psi | 11441 | psi |
| 4 | 396.98 | 39.70 | 436.67 | 126.65 | 5369 psi | 9640 | psi |
| | | | | | 5678 psi | 9812 | psi |
| | | | | | 5456 psi | 9865 | psi |
| 5 | 272.95 | 27.30 | 600.50 | 99.26 | 6306 psi | 7485 | psi |
| | | | | | 5813 psi | 7824 | psi |
| | | | | | 5443 psi | 7723 | psi |

As shown in Table 1, examples number 1, 2 and 3, include activator 30 (sodium carbonate) at 5%, 10% and 15% by weight of slag 20, respectively. These mixes included a binder powder 60 to sand (aggregate 40) ratio of 1:1.5 and were cured at ambient temperature for 7 days and 28 days to measure the compressive strength of the produced mortar 90. Examples 4 and 5 include activator 30 (sodium carbonate) at 10% by weight of slag 20 with solid alkali-activated binder powder 60 to sand (aggregate 40) ratios of 1:1 and 1:2, respectively.

Examples of concrete formulations made from solid alkali-activated binder powder 60 from single precursor slag 20 and single activator 30 using varying grinding time and the initial setting time and the compressive strength of said solid alkali-activated binder powder 60 and concrete 90 made from it, respectively are presented below in Table 2. As shown in Table 2, increasing the grinding time by ball milling the slag 20 and activator 30 together reduces the initial setting time of the binder paste without the need for any additional accelerator or plasticizer.

TABLE 2

| | | | | | | | 28-day | | |
|---|---|---|---|---|---|---|---|---|---|
| | Binder (g) | | | | | 7-day ambient | ambient cured | | |
| | | Solid | | | | cured concrete | concrete | | |
| | | Sodium | Fine | Coarse | | cylinder | cylinder | | Initial setting |
| Example | Slag | carbonate | aggregate | aggregate | Water | Compressive | Compressive | Grinding | time of binder |
| Number | (Precursor) | (Activator) | (g) | (g) | (g) | strength (psi) | strength (psi) | method | paste |
| 6 | 5795 | 305 | 9000 | 12000 | 2000 | 4117 psi | 4200 psi | Ground at | 68 minutes |
| | | | | | | 4105 psi | 4850 psi | 20000 | |
| | | | | | | 3973 psi | 5200 psi | rpm for 60 | |
| 7 | 5490 | 610 | 9000 | 12000 | 2080 | 4661 psi | 5859 psi | seconds | 56 minutes |
| | | | | | | 4474 psi | 6015 psi | | |
| | | | | | | 4822 psi | 5729 psi | | |
| 8 | 5185 | 915 | 9000 | 12000 | 2125 | 6471 psi | 8000 psi | | 47 minutes |
| | | | | | | 6160 psi | 6800 psi | | |
| | | | | | | 6636 psi | 6728 psi | | |
| 9 | 5490 | 610 | 9000 | 12000 | 1945 | 6075 psi | 6363 psi | Ball | 35 minutes |
| | | | | | | 6069 psi | 6459 psi | milled for | |
| | | | | | | 6248 psi | 6678 psi | 90 | |
| | | | | | | | | minutes at | |
| | | | | | | | | 90 rpm | |
| 10 | 5490 | 610 | 9000 | 12000 | 2014 | 6323 psi | 6210 psi | Ball | 20 minutes |
| | | | | | | 5868 psi | 6125 psi | milled for | |
| | | | | | | 5989 psi | 6200 psi | 180 | |
| | | | | | | | | minutes at | |
| | | | | | | | | 90 rpm | |
| 11 | 5490 | 610 | 9000 | 12000 | 2095 | 5268 psi | 5590 psi | Ball | 17 minutes |
| | | | | | | 5543 psi | 5762 psi | milled for | |
| | | | | | | 5498 psi | 5562 psi | 360 | |
| | | | | | | | | minutes at | |
| | | | | | | | | 90 rpm | |
| 12 | 5490 | 610 | 9000 | 12000 | 2212 | 5217 psi | 5392 psi | Ball | 12 minutes |
| | | | | | | 5140 psi | 5412 psi | milled for | |
| | | | | | | 5449 psi | 5396 psi | 540 | |
| | | | | | | | | minutes at | |
| | | | | | | | | 90 rpm | |

Examples 6, 7 and 8 pertain to mortar 90 made from solid alkali-activated binder powder 60 from single precursor slag 20 and single activator 30 where activator 30 (sodium carbonate) is 5%, 10% and 15% by weight of slag 20, respectively. The solid alkali-activated binder powder 60 in these mixes was ground at a high rpm of 20000. A reduced rpm and a more industrially and commercially feasible approach with a controlled rpm of 90 was used to ball mill solid alkali-activated binder powder 60 for examples 9, 10, 11 and 12. The activator 30 sodium carbonate in these mixes was 10% the weight of slag 20. Table 2 shows increasing the grinding time reduced the initial setting time significantly of the examples.

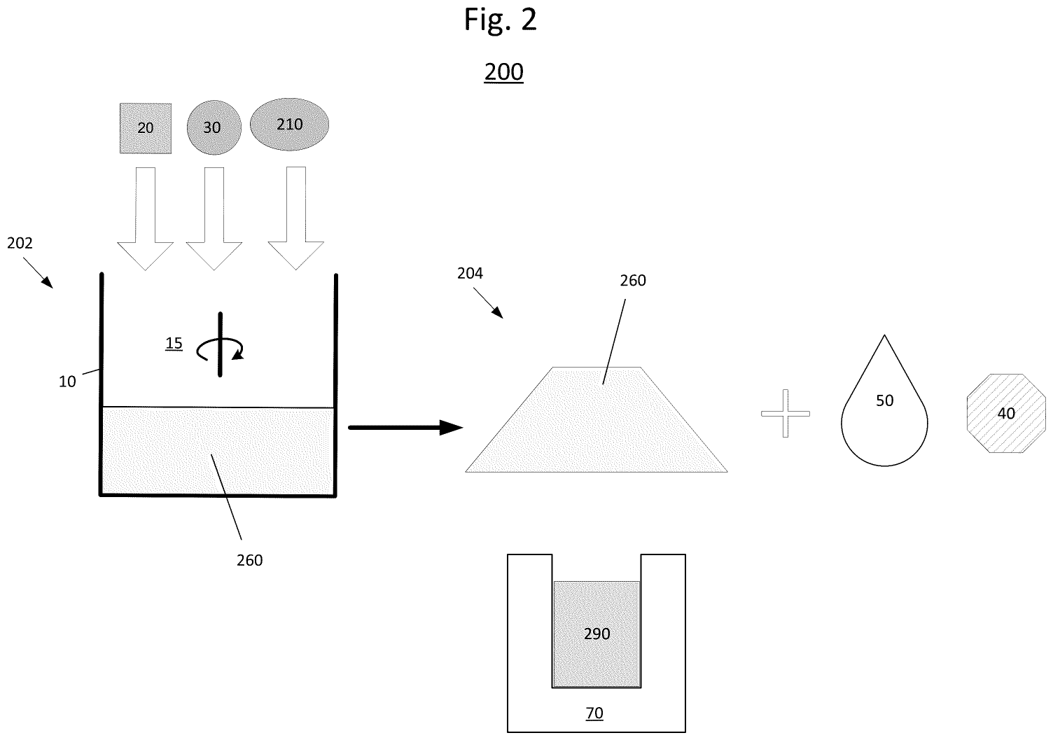

FIG. 2 illustrates another example system that can be utilized to produce a solid alkali-activated binder powder in accordance with at least some embodiments described herein. As discussed in more detail below, the solid alkali-activated binder powder produced using system 200 may be a one-part cement-free alkali-activated ready-to-use powdered binder and an effective building material for general construction. Those components in FIG. 2 that are labeled identically to components of FIG. 1 will not be described again for the purposes of brevity.

System 200 may include milling equipment 10 with chamber 15, slag 20, first activator 30, second activator 210, aggregate 40, water 50, and mold 70. Milling equipment 10 may dry grind material placed within chamber 15. Slag 20 may be blast furnace slag. First activator may be a solid metal carbonate-based alkali activator such as sodium carbonate which may be 99% pure with a metal oxide equivalent ranging from about 1.0 to about 3.0, potassium carbonate, magnesium carbonate, and/or combinations thereof.

Second activator 210 may be a solid alkaline silicate activator and may be solid dry powder, flakes, beads or granules. Second activator 210 may include alkaline silicate sources including sodium silicate, potassium silicate, and or combinations thereof. Second activator 210 may include sodium silicate including 99% pure sodium silicate anhydrous or pentahydrate. The addition of second activator 210 may reduce a cumulative dosage of activators in a binder while still achieving high early strength and quick setting/hardening.

At 202, slag 20, first activator 30 and second activator 210 may be placed separately, or in any combination, into chamber 15 of milling equipment 10. Milling equipment 10 may dry grind slag 20, first activator 30, and second activator 210 into a dry powder 260. Grinding may mix dry slag 20, first activator 30, and second activator 210 at an rpm ranging from 60 to 20,000. Milling equipment 10 may dry grind slag 20, first activator 30, and second activator 210 for a duration ranging from about 5 minutes to about 540 minutes. Milling may be performed to obtain simultaneous and synergistic chemical reactions among slag 20, first activator 30, and second activator 210 so as to convert the material from unreactive to reactive and produce a powder capable of instant activation when in contact with water. Milling may be performed to slag 20, first activator 30, and second activator 210 to obtain enhanced functionality for achieving bonding of the constituents within the concrete system to obtain desired functionality for a targeted application. Dry powder 260 may be a ‘ready-to-use powdered binder’ and may be a dry fine powder which may only require addition of water to harden and form a cement-like material.

At 204, dry powder 260 may be removed from milling equipment 10. Dry powder 260 may include milled slag 20, milled first activator 30, and milled second activator 210, and may have particles of a uniform size ranging from between submicron to nano. Dry powder 260 may have particles from about 20 microns to about 150 microns. Dry powder 260 may be a one-part cement-free alkali-activated ready-to-use powdered binder from a single slag 20 precursor and two activators 30, 210. One-part cement-free alkali-activated ready-to-use powdered binder of dry powder 260 may include about 80% to about 96% by weight of slag 20, about 2% to about 10% by weight of metal carbonate-based alkali first activator 30, and about 2% to about 10% by weight of alkaline silicate second activator 210.

Water 50 and optional aggregate 40 may be added to solid alkali-activated binder dry powder 260 to form a mortar for casting the materials in a mold 70 of desired dimensions. Aggregates 40 may be both fine (<4.75 mm sand) and coarse (4.75-20 mm river rock, crushed rocks or ballast stones) and when mixed with solid alkali-activated binder dry powder 260 and water 50 may result in a manufacture mortar or concrete. Solid alkali-activated binder dry powder 260 may not require the addition of a hazardous alkaline activator solution to make cementitious materials. Solid alkali-activated binder dry powder 260 mixed with water 50 may harden/set at ambient room temperatures of 65° F. to 90° F. resulting in mortar 290.

Table 3 includes examples of mortar 290 formulations made from solid alkali-activated binder dry powder 260 from single precursor slag 20 and two activators 30, 210, and the compressive strength values of 7-day and 28-day ambient cured mortar 290 produced.

TABLE 3

| | Binder (g) | | | | | Compressive | |
|---|---|---|---|---|---|---|---|
| | | | Solid | | | strength (psi) | |
| | | Solid Sodium | Sodium | Fine | | 7-day | 28-day |
| Example | Slag | carbonate | Silicate | aggregate | | ambient | ambient |
| Number | (Precursor) | (Activator) | (Activator) | (g) | Water (g) | cured | cured |
| 13 | 300 | 15 | 15 | 495 | 90 | 6622 psi | 10537 psi |
| | | | | | | 7384 psi | 9534 si |
| | | | | | | 7599 psi | 9741 si |
| 14 | 300 | 15 | 15 | 660 | 92.4 | 7275 psi | 8432 psi |
| | | | | | | 6991 psi | 9334 psi |
| | | | | | | 6785 psi | 8912 psi |

Examples 13 and 14 were prepared with precursor slag 20, solid sodium carbonate first activator 30, and solid sodium silicate second activator 210. The dosage of each of activators 30 and 210 individually was 5% by weight of slag 20. Examples 13 and 14 had binder to aggregate 40 (sand) ratios of 1:1.5 and 1:2, respectively. Examples 13 and 14 show a reduction in the cumulative dosage of activator 30, 210 over the single activator preparation resulting in a high compressive strength mortar.

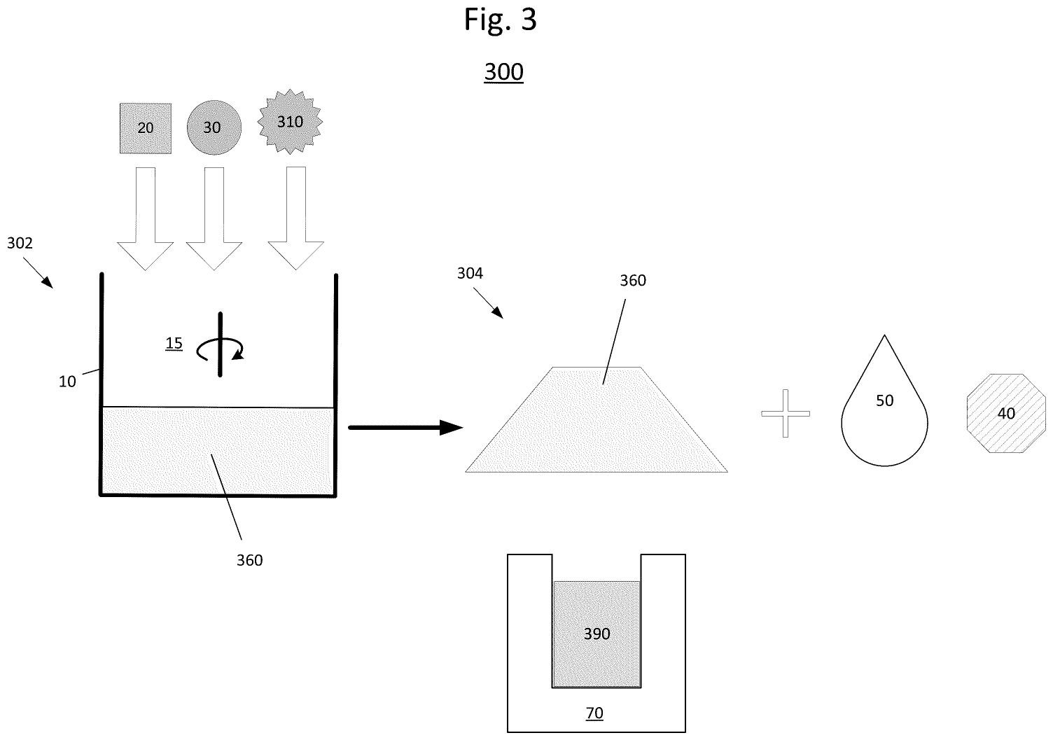

FIG. 3 illustrates yet another exemplary system that can be utilized to produce a solid alkali-activated binder arranged in accordance with at least some embodiments described herein. As discussed in more detail below, the solid alkali-activated binder produced using system 300 may be a one-part cement-free alkali-activated ready-to-use powdered binder and an effective building material for general construction. Those components in FIG. 3 that are labeled identically to components of FIGS. 1-2 will not be described again for the purposes of brevity.

System 300 may include milling equipment 10 with chamber 15, slag 20, activator 30, biochar 310, aggregate 40, water 50, and mold 70. Milling equipment 10 may dry grind material placed within chamber 15. Slag 20 may be blast furnace slag. First activator may be a solid metal carbonate-based alkali activator such as sodium carbonate which may be 99% pure with a metal oxide equivalent ranging from 1.0 to 3.0, potassium carbonate, or magnesium carbonate.

Biochar 310 may include rice husk, sawdust, bamboo waste, dry grass, sugar cane, sludge, corn cob or mixtures thereof. Biochar 310 may be granular, angular, elongated or fine powdered biochar derived from rice husk. Biochar 310 added to one-part cement-free alkali-activated ready-to-use powdered binder may ensure a safe use of carbon rich waste, may delay and aid in controlled hardening/setting, may improve freeze thaw resistance, and may improve thermal insulation of mortar or concrete prepared from the binder. A specific gravity of biochar 310 may be in the range of about 0.40 to about 0.80.

At 302, slag 20, activator 30 and biochar 310 may be placed separately, or in any combination, into chamber 15 of milling equipment 10. Milling equipment 10 may dry grind slag 20, activator 30, and biochar 310 into a dry powder 360. Grinding may mix dry slag 20, activator 30, and biochar 310 at an rpm ranging from 60 to 20,000 for a time ranging from 5 minutes to 150 minutes. Milling may be performed to obtain simultaneous and synergistic chemical reactions among slag 20, 30, and biochar 310 so as to convert the material from unreactive to reactive and produce a powder capable of instant activation when in contact with water and to obtain enhanced functionality for achieving bonding of the constituents within the concrete system to obtain desired functionality for a targeted application. Dry powder 360 may be a ‘ready-to-use powdered binder’ and may be a dry fine powder which may only require addition of water to harden and form a cement-like material.

At 304, dry powder 360 may be removed from milling equipment 10. Dry powder 360 may include milled slag 20, milled activator 30, and milled biochar 310, and may have particles of a uniform size ranging from between submicron to nano. Dry powder 360 may have particles from about 20 microns to about 150 microns. Dry powder 360 may be a one-part cement-free alkali-activated ready-to-use powdered binder from a single slag 20 precursor, activator 30, and biochar 310. One-part cement-free alkali-activated ready-to-use powdered binder of dry powder 230 may include about 50% to about 93% by weight of slag 20, about 2% to about 10% by weight of metal carbonate-based alkali activator 30, and about 5% to about 25% by weight of biochar 310.

Water 50 and optional aggregate 40 may be added to solid alkali-activated binder dry powder 360 to form a mortar for casting the materials in a mold 70 of desired dimensions. Aggregates 40 may be both fine (<4.75 mm sand) and coarse (4.75-20 mm river rock, crushed rocks or ballast stones) and when mixed with solid alkali-activated binder dry powder 360 and water 50 may result in a manufacture mortar or concrete. Solid alkali-activated binder dry powder 360 may not require the addition of a hazardous alkaline activator solution to make cementitious materials. Solid alkali-activated binder dry powder 360 mixed with water 50 may harden/set at ambient room temperatures of 65° F. to 90° F. resulting in mortar 390.

Table 4 shows examples of mortar 390 formulations made from one-part cement-free alkali activated ready-to-use powdered binder 360 from single precursor slag 20, activator 30 and biochar 310 and the compressive strength values of 28-day ambient cured mortar 390 produced.

TABLE 4

| | Binder (g) | | | | | Compressive |
|---|---|---|---|---|---|---|
| | | Solid Sodium | | Fine | | strength (psi) |
| Example | Slag | carbonate | | aggregate | Water | 28-day |
| Number | (Precursor) | (Activator) | Biochar | (g) | (g) | ambient cured |
| 15 | 300 | 30 | 15 | 502 | 107 | 5823 psi |
| | | | | | | 6428 psi |
| | | | | | | 6498 psi |
| 16 | 300 | 30 | 30 | 540 | 127 | 2983 psi |
| | | | | | | 2670 psi |
| | | | | | | 3020 psi |
| 17 | 300 | 30 | 45 | 562 | 140 | 1732 psi |
| | | | | | | 1538 psi |
| | | | | | | 1389 psi |

Examples 15, 16 and 17 were prepared by grinding together the precursor slag 20, activator 30 and biochar 310 to prepare binder powder 360 which was further used to make mortar 390 with binder 360 to aggregate 40 (sand) ratio of 1:1.5. The amount of sodium carbonate activator 30 in examples 15, 16 and 17 was 10% by weight of slag 20 and the amount of biochar 310 varied at 5%, 10% and 15% by weight of slag 20 respectively. Examples 15, 16, 17 produced mortar 390 which used a carbon rich source and provided controlled hardening/setting, improved freeze thaw resistance, and thermal insulation of the mortar or concrete.

A powdered solid alkali-activated binder in accordance with the present disclosure may provide a cement-free alkali-activated ready-to-use powdered binder that does not need accelerators to achieve early strength and early setting. A powdered solid alkali-activated binder in accordance with the present disclosure may provide a one-part cement-free alkali-activated ready-to-use powdered binder by using non-hazardous activator that can be used in larger scale in field applications. A powdered solid alkali-activated binder in accordance with the present disclosure may provide a complete or partial replacement of cement to achieve superior mechanical and durability properties when used in mortar or concrete in field applications. A powdered solid alkali-activated binder in accordance with the present disclosure may provide an economical, environmentally friendly, sustainable alternative to cement. A powdered solid alkali-activated binder in accordance with the present disclosure may provide material which is workable and strong enough to be used in general construction purposes, including sewage pipes, rainwater drains, oil well plugging, artificial reefs, pre-cast concrete, prestressed concrete and bricks.

Finally, the processes and techniques described herein are not inherently related to any apparatus and may be implemented by any suitable combination of components. Further, various types of general-purpose devices may be used in accordance with the teachings described herein. It may also prove advantageous to construct specialized apparatus to perform the method steps described herein. This disclosure has been described in relation to the examples, which are intended in all respects to be illustrative rather than restrictive.

The foregoing description is only illustrative of the present disclosure. Various alternatives and modifications can be devised by those skilled in the art without departing from the disclosure. Accordingly, the present disclosure is intended to embrace all such alternatives, modifications, and variances. The embodiments described with reference to the attached drawing figures are presented only to demonstrate certain examples of the disclosure. Other elements, steps, methods, and techniques that are insubstantially different from those described above and/or in the appended claims are also intended to be within the scope of the disclosure.

What is claimed is:

1. A one-part, cement-free, ready-to-use, powdered, solid alkali-activated binder formulation for making a high strength and early setting material when combined with an aggregate and water, the solid alkali-activated binder formulation comprising:
slag; and
a solid metal carbonate-based alkali activator.

2. The solid alkali-activated binder formulation of claim 1, wherein the slag is blast furnace slag, steel slag, electric furnace slag, ladle slag, nonferrous slag, or combinations thereof.

3. The solid alkali-activated binder formulation of claim 1, wherein the slag is blast furnace slag and has a comprehensive basicity in of about 0.85 to about 4.0.

4. The solid alkali-activated binder formulation of claim 3, wherein the slag is blast furnace slag and has a comprehensive basicity of about 0.85 to about 1.20.

5. The solid alkali-activated binder formulation of claim 1, wherein the slag has an amount of CaO of about 10% to about 60% by weight of the slag.

6. The solid alkali-activated binder formulation of claim 1, wherein a ratio of alumina to silica of the slag is about 0.05:6.0.

7. The solid alkali-activated binder formulation of claim 1, wherein the activator includes at least one of sodium carbonate, potassium carbonate, magnesium carbonate, or mixtures thereof.

8. The solid alkali-activated binder formulation of claim 7, wherein the activator is sodium carbonate which is 99% pure with a metal oxide equivalent ranging from about 1.0 to about 3.0.

9. The solid alkali-activated binder formulation of claim 8, wherein the binder comprises about 80% to about 98% by weight of the slag and about 2% to about 20% by weight of the metal carbonate-based alkali activator.

10. The solid alkali-activated binder formulation of claim 1, further comprising a solid alkaline silicate activator.

11. The solid alkali-activated binder formulation of claim 10, wherein the alkaline silicate activator includes at least one of sodium silicate, potassium silicate, or combinations thereof.

12. The solid alkali-activated binder formulation of claim 10, wherein the alkaline silicate activator includes 99% pure sodium silicate anhydrous or pentahydrate.

13. The solid alkali-activated binder formulation of claim 10, wherein the binder comprises about 80% to about 96% by weight of the slag, about 2% to about 10% by weight of the metal carbonate-based alkali activator, and about 2% to about 10% by weight of the alkaline silicate activator.

14. The solid alkali-activated binder formulation of claim 1, further comprising biochar.

15. The solid alkali-activated binder formulation of claim 14, wherein the biochar includes rice husk, sawdust, bamboo waste, dry grass, sugar cane, sludge, corn cob or mixtures thereof.

16. The solid alkali-activated binder formulation of claim 14, wherein the biochar includes granular, angular, elongated or fine powdered biochar derived from rice husk.

17. The solid alkali-activated binder formulation of claim 14, wherein the biochar has a specific gravity in the range of about 0.40 to about 0.80.

18. A method of making a solid alkali-activated binder formulation, the method comprising:
placing slag into a chamber of milling equipment;
placing a solid metal carbonate-based alkali activator into the chamber of the milling equipment; and
milling the slag and the metal carbonate-based alkali activator to produce a dry solid alkali-activated binder formulation for making a high strength and early setting material when combined with an aggregate and water.

19. The method of claim 18, further comprising:
mixing aggregate and water with the dry solid powder to produce a mortar; and
casting the mortar into a mold.

20. A one-part, cement-free, ready-to-use, powdered, solid alkali-activated binder formulation for making a high strength and early setting material when combined with an aggregate and water, the solid alkali-activated binder comprising:
blast furnace slag with a comprehensive basicity in of about 0.85 to about 1.20 and an amount of CaO in a range of 10%-60% by weight of the slag; and
solid sodium carbonate as a metal carbonate-based alkali activator;
wherein the solid alkali-activated binder comprises about 80% to about 98% by weight of the blast furnace slag and about 2% to about 20% by weight of the metal carbonate-based alkali activator.
